(19) United States
(12) Patent Application Publication
(10) Pub. No.: US 2010/0009626 A1
(43) Pub. Date: Jan. 14, 2010

(54) SYSTEM AND METHOD TO PREVENT SPECIFIED CELL PHONE FUNCTIONALITY WHILE IN MOTION

(76) Inventor: Patrick Talman Farley, Dallas, TX (US)

Correspondence Address: Patrick T. Farley, 5818 Velasco Avenue, Dallas, TX, 75206, US

(21) Appl. No.: 12/170,047

(22) Filed: Jul. 9, 2008

(51) Int. Cl. H04B 1/06; H04M 1/00

(52) U.S. Cl. 455/26.1; 455/556.1

(57) ABSTRACT

A system and method for a mobile communication device, such as a cell phone, to prevent the usage of specified functionality, such as text messaging, while driving a vehicle based on the calculation of the velocity of the cell phone with respect to the earth.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

1. Field of the Invention Art

The present invention relates generally to mobile communication devices and more particularly, to a system and method for mobile communication devices, such as cell phones, to prevent specified functionality, such as text messaging, while the device is in motion at or greater than a specified velocity.

2. Description of the Related Art

Recently, there have been many technical advances that have increased the number of ways in which people can communicate with one another. Along with these new means of communication have come new hazards of distraction while operating machinery such as driving an automobile. There has been a surge of automobile accidents related to cell phone conversations, email, and text messaging. Many of these accidents have been fatal. As evidenced by this trend, it only takes a few moments of distraction to cause a serious accident while driving an automobile.

Thus, a need exists for a system to prevent certain functionality of a cell phone, such as voice communication, email, or text messaging, when necessary while driving a vehicle.

### SUMMARY OF THE INVENTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a cellular telephone that provides the ability to disable text messaging when the cellular telephone is in motion, which comprises a text messaging component and a velocity measuring component that is capable of measuring the velocity of the cellular telephone relative to the surface of the earth and where the text messaging component is disabled when the velocity measuring component determines that the cellular telephone has a velocity which is greater than a predetermined velocity.

It is a further object of the present invention to provide a communication device that provides the ability to disable specific communication functionality while the communication device is in motion, the communication device comprising a communication component and a velocity measuring component capable of measuring the velocity of the communication device relative to the surface of the earth. The functional component is disabled when the velocity measuring component determines that the communication device has a velocity which is greater than a predetermined velocity.

It is yet a further object of the present invention to provide a method for a cellular telephone to provide the ability to disable text messaging when the cellular telephone is in motion, the method comprising: providing a text messaging component; providing a velocity measuring component capable of measuring the velocity of the cellular telephone relative to the surface of the earth; and disabling the text messaging component when the velocity measuring component determines that the cellular telephone has a velocity which is greater than a predetermined velocity.

It is another object of the present invention to provide a method for a communication device to provide the ability to disable specific communication functionality while the communication device is in motion, the method comprising: providing a communication component; providing a velocity measuring component capable of measuring the velocity of the communication device relative to the surface of the earth; disabling the communication component when the velocity measuring component determines that the communication device has a velocity which is greater than a predetermined velocity.

These together with other objects of the invention, along with the various features of novelty which comprise the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

### BRIEF DESCRIPTION OF THE SEVERAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 depicts an embodiment of the present invention which utilizes GPS to determine the velocity of the cell phone; and

FIG. 2 depicts an embodiment of the present invention which utilizes the rate of hand off between cells to determine the velocity of the cell phone.

### DETAILED DESCRIPTION OF THE INVENTION

The following discussion is presented to enable a person skilled in the art to make and use the invention. The principles described herein can be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

In one embodiment of the present invention, a mobile communication device, such as a cell phone, determines the velocity of the cell phone relative to the earth and disables specified functionality of the cell phone if the cell phone is moving at a velocity greater than a specified rate.

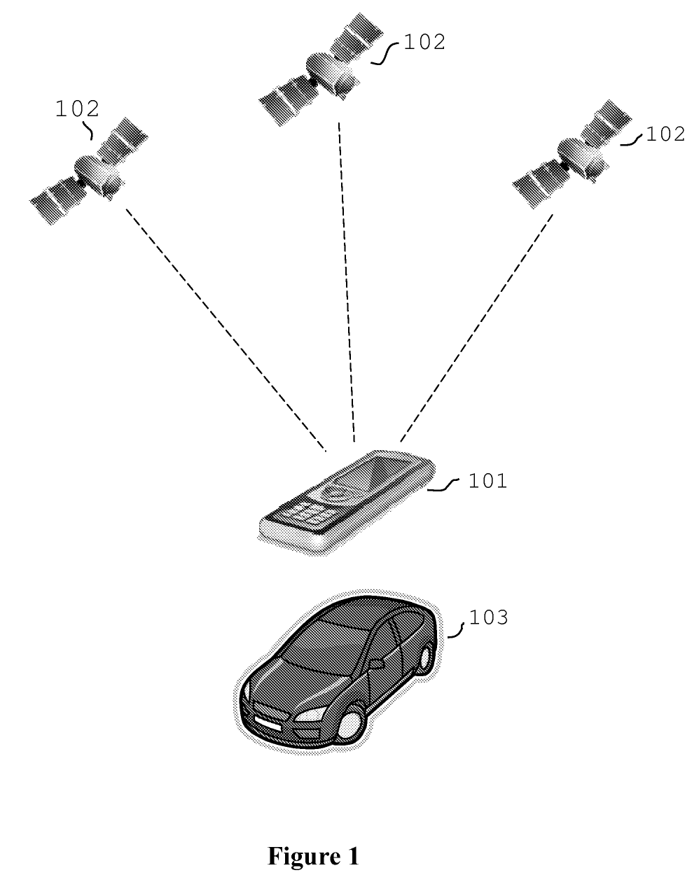

Referring now to the drawings and initially to FIG. 1, a cell phone 101 in one embodiment of the present invention has circuitry which is capable of determining the velocity of the cell phone 101. In an embodiment, the circuitry includes a global positioning system (GPS) receiver. It utilizes the reception of signals from multiple satellites 102 to determine the location of the cell phone relative to the earth. This information combined with timing information received from the satellites 102 or elsewhere enables the circuitry to determine the velocity of the cell phone 101 with respect to the earth.

In an embodiment, circuitry in the cell phone 101 determines, based on the GPS information, whether the cell phone 101 is traveling at a velocity greater than some predetermined rate. If the cell phone 101 is traveling at a velocity greater than the predetermined rate, specified functionality of the cell phone 101, such as text messaging, email, or voice communication, is disabled. This prevents the operator of a vehicle, such as a car 103, from text messaging, etc. while driving. Systems and methods to determine velocity based on GPS information are well known by persons skilled in the art.

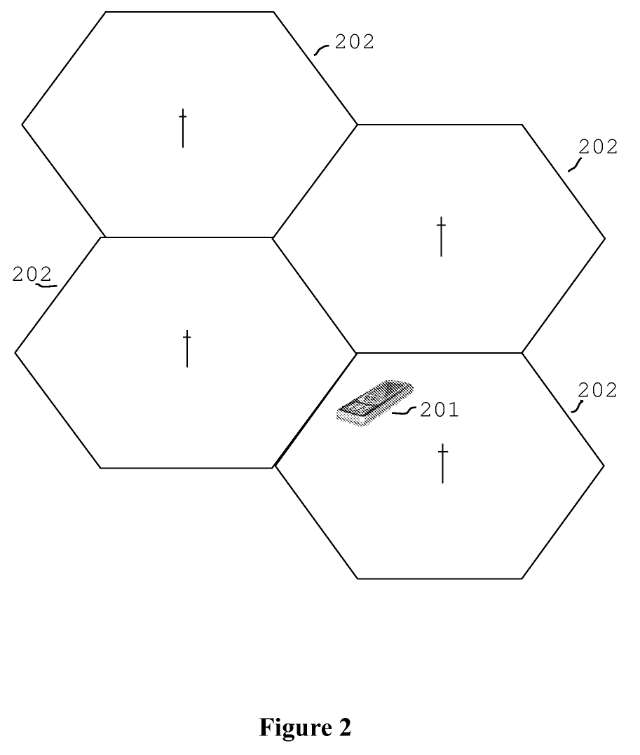

With reference now to FIG. 2, in an alternative embodiment of the present invention, the velocity of the cell phone 201 is determined by the rate at which the cell phone 201 is “handed off” between cells 202. The size of cells 202 in a cellular network is typically consistent. Therefore, by calculating the rate at which the cell phone 201 moves from one cell 202 to each of subsequent cells 202, circuitry can calculate the approximate velocity of the cell phone 201. In locations where cells are inconsistently sized and/or spaced, a rough estimation of velocity is still calculable. Systems and methods for calculating estimated velocity based on the rate of hand offs between cells are well known by persons skilled in the art.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

In addition, while a particular feature of the invention may have been disclosed with respect to only one of several embodiments, such feature may be combined with one or more other features of the other embodiments as may be desired. Additionally, for the most part, details concerning particular chemical reactions, chemical properties, and the like, have been omitted inasmuch as such details are not considered necessary to obtain a complete understanding of the present invention, and are considered to be within the understanding of persons of ordinary skill in the relevant art.

It is therefore, contemplated that the claims will cover any such modifications or embodiments that fall within the true scope of the invention.

What is claimed is:

1. A cellular telephone providing the ability to disable text messaging when the cellular telephone is in motion, the cellular telephone comprising:
a text messaging component; and
a velocity measuring component, capable of measuring the velocity of the cellular telephone relative to the surface of the earth,
wherein said text messaging component is disabled when said velocity measuring component determines that the cellular telephone has a velocity which is greater than a predetermined velocity.

2. The cellular telephone of claim 1, wherein the velocity measuring component utilizes global positioning system (GPS) information to determine the velocity of the cellular telephone.

3. The cellular telephone of claim 2, wherein the velocity measuring component utilizes a timing device to determine the velocity of the cellular telephone.

4. The cellular telephone of claim 1, wherein the velocity measuring component utilizes the rate at which hand offs occur between cells to determine the velocity of the cellular telephone.

5. A communication device providing the ability to disable specific communication functionality while the communication device is in motion, the communication device comprising:
a communication component; and
a velocity measuring component, capable of measuring the velocity of the communication device relative to the surface of the earth,
wherein said functional component is disabled when said velocity measuring component determines that the communication device has a velocity which is greater than a predetermined velocity.

6. The communication device of claim 5, wherein the communication component is a voice communication component.

7. The communication device of claim 5, wherein the communication component is an email communication component.

8. The communication device of claim 5, wherein the velocity measuring component utilizes global positioning system (GPS) information to determine the velocity of the communication device.

9. The communication device of claim 8, wherein the velocity measuring component utilizes a timing device to determine the velocity of the communication device.

10. The communication device of claim 5, wherein the velocity measuring component utilizes the rate at which hand offs occur between cells to determine the velocity of the communication device.

11. A method for a cellular telephone to provide the ability to disable text messaging when the cellular telephone is in motion, the method comprising:
providing a text messaging component;
providing a velocity measuring component, capable of measuring the velocity of the cellular telephone relative to the surface of the earth; and
disabling said text messaging component when said velocity measuring component determines that the cellular telephone has a velocity which is greater than a predetermined velocity.

12. The method of claim 11, wherein the velocity measuring component utilizes global positioning system (GPS) information to determine the velocity of the cellular telephone.

13. The method of claim 12, wherein the velocity measuring component utilizes a timing device to determine the velocity of the cellular telephone.

14. The method of claim 11, wherein the velocity measuring component utilizes the rate at which hand offs occur between cells to determine the velocity of the cellular telephone.

15. A method for a communication device to provide the ability to disable specific communication functionality while the communication device is in motion, the method comprising:
providing a communication component;
providing a velocity measuring component, capable of measuring the velocity of the communication device relative to the surface of the earth; and
disabling said communication component when said velocity measuring component determines that the communication device has a velocity which is greater than a predetermined velocity.

16. The method of claim 15, wherein the communication component is a voice communication component.

17. The method of claim 15, wherein the communication component is an email communication component.

18. The method of claim 15, wherein the velocity measuring component utilizes global positioning system (GPS) information to determine the velocity of the communication device.

19. The method of claim 18, wherein the velocity measuring component utilizes a timing device to determine the velocity of the communication device.

20. The method of claim 15, wherein the velocity measuring component utilizes the rate at which hand offs occur between cells to determine the velocity of the communication device.
